(19) United States
(12) Patent Application Publication
(10) Pub. No.: US 2007/0141451 A1
(43) Pub. Date: Jun. 21, 2007

(54) Housing structure for battery pack

(75) Inventors: Shuhei Marukawa, Toyohashi-shi (JP); Toyohiko Eto, Toyota-shi (JP); Masahiro Misu, Nisshin-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Panasonic EV Energy Co., Ltd., Kosai-shi (JP)

(21) Appl. No.: 11/643,419

(22) Filed: Dec. 20, 2006

(30) Foreign Application Priority Data
Dec. 20, 2005 (JP) 2005-366900

(51) Int. Cl. H01M 2/10; B60R 16/04

(52) U.S. Cl. 429/100; 180/68.5

(57) ABSTRACT

A battery pack has a battery stack built therein. A case for the battery pack includes an upper case and a lower case. The upper case is not flat, but forms an arch shape having a curved surface. The upper case has a chamber space formed above the built-in battery stack, and cooling air taken in through an air intake port is supplied to the chamber space. The upper case formed in the shape of an arch prevents deformation of the chamber space against a load applied from above, and adjusts the cooling properties of the battery stack.

This application claims priority to Japanese Patent Application No. 2005-366900, filed on Dec. 20, 2005, which is incorporated herein by reference in its entirety.

### BACKGROUND OF THE INVENTION

1. Field of the Invention

The present invention relates to a housing structure for a battery pack, and, in particular, relates to the housing structure for the battery pack to be mounted on a vehicle.

2. Description of the Related Art

Conventionally, battery packs for storing power to be supplied to a driving motor (vehicle power supplies) are mounted on hybrid electric vehicles, fuel cell vehicles, or electric vehicles. Battery packs each have an upper case and a lower case for protecting an internal battery stack, and the upper case is provided with a reinforcing structure, such as the structure in which beads are formed in the shape of grooves or the like.

Japanese Patent Laid-Open Publication No. 2005-302590 describes a structure wherein a battery pack is mounted on a rear side of a vehicle between wheel houses of rear tires, and describes that grooves are formed on a housing for the battery pack on a rear side in a front and rear direction of the vehicle with reference to end portions of the wheel houses of the vehicle to thereby improve the stiffness of the housing.

FIG. 5 shows a housing structure for the battery pack according to the Related Art. A battery pack 100 is located between wheel houses 302 and 306 for rear tires 200 and 202, or, in other words, under a rear seat of a vehicle. A battery case 102 serving as a housing for the battery pack 100 includes an upper case and a lower case, is provided with an air intake port, and is provided with a cooling fan 104 within the battery case 102. The air intake port is connected to a passenger compartment on a front side of the vehicle. By causing the cooling fan 104 to rotate, a negative pressure is generated within the battery case 102, and cooling air is supplied from the interior of the passenger compartment through the air intake port to the inside of the battery case 102. For the battery case 102, a bead portion 106 formed in the shape of grooves to protrude toward the inside of the battery case is provided as a reinforcing portion for improving the stiffness. The bead portion 106 is provided in the front and rear direction of the vehicle.

The battery pack 100 receives a supply of cooling air for cooling a battery stack as described above. In order to effectively cool the battery stack through the use of the cooling air, it is preferable that chamber spaces are formed above and below the battery stack, and the battery stack is cooled by passing the cooling air from above to below the battery stack, or from below to above the battery stack, and it is preferable that the upper case and the lower case are formed of sheet metal, and the chamber spaces are secured between the upper case and the battery stack, and between the lower case and the battery stack.

However, in cases where a battery pack 100 is mounted under a luggage space of the vehicle, or where, even when it is mounted under the rear seat of the vehicle, if the rear seat is a fold-down type and has a structure capable of mounting luggage thereon, a load of the luggage or the like may be applied onto the upper case, and the load may cause deformation of the upper case, resulting in reduction or collapse of the chamber space, which further leads to a decrease in cooling efficiency for the battery stack.

### SUMMARY OF THE INVENTION

The present invention provides a housing structure which has sufficient load-bearing characteristics even when it is located under a luggage space, under a fold-down type seat, or in any other locations where luggage or the like may be mounted and a load may be applied, and which is thus capable of maintaining a cooling efficiency for an internal battery stack.

According to one aspect of the present invention, there is provided a housing structure for a battery pack to be mounted on a vehicle, the housing structure including an upper case for covering an upper portion of a built-in battery stack, wherein at least a part of the upper case has a curved surface formed to protrude upward.

In one embodiment of the present invention, the upper case has a chamber space formed above the battery stack, and a medium for adjusting a temperature of the battery stack, for example, cooling air is supplied to the chamber space.

Further, according to another aspect of the present invention, there is provided a housing structure for a battery pack to be mounted on a vehicle, the housing structure including an upper case for covering an upper portion of a built-in battery stack; and a lower case for covering a lower portion of the battery stack, wherein a first chamber space is formed between the upper case and the upper portion of the battery stack; a second chamber space is formed between the lower case and the lower portion of the battery stack; a medium for adjusting a temperature of the battery stack is supplied so as to flow from one of the first chamber space and the second chamber space to another; and the upper case is formed with a curved surface such that an amount of supply of the medium relatively increases at a central portion of the battery stack, and such that an amount of supply of the medium relatively decreases at end portions of the battery stack.

According to the present invention, the load-bearing characteristics for loads applied from above are improved by forming the upper case not with a flat surface but with a curved surface. In addition, when the chamber space for the temperature adjusting medium is formed between the upper case and the battery stack, deformation or collapsing of the chamber space is effectively prevented as a result of improvement in the load-bearing characteristics, and deterioration of the temperature characteristics of the battery stack caused by the temperature adjusting medium is prevented. Further, by forming the upper case with the curved surface, it is possible to adjust the chamber space to adjust the temperature characteristics of the battery stack.

### BRIEF DESCRIPTION OF THE DRAWINGS

An embodiment of the present invention will be described in further detail based on the following drawings, wherein:

FIG. 1 is a perspective view of a battery pack according to an embodiment of the present invention;

FIG. 2 is a cross-sectional view taken along a plane y-z in FIG. 1;

FIG. 3 is a diagram illustrating an internal structure of the battery pack shown in FIG. 1;

FIG. 4 is a diagram illustrating how the battery pack, shown in FIG. 1, is mounted on a vehicle; and

FIG. 5 is a diagram showing a structure of a battery pack according to the related art.

### DESCRIPTION OF PREFERRED EMBODIMENT

An embodiment of the present invention will be described below with reference to the drawings.

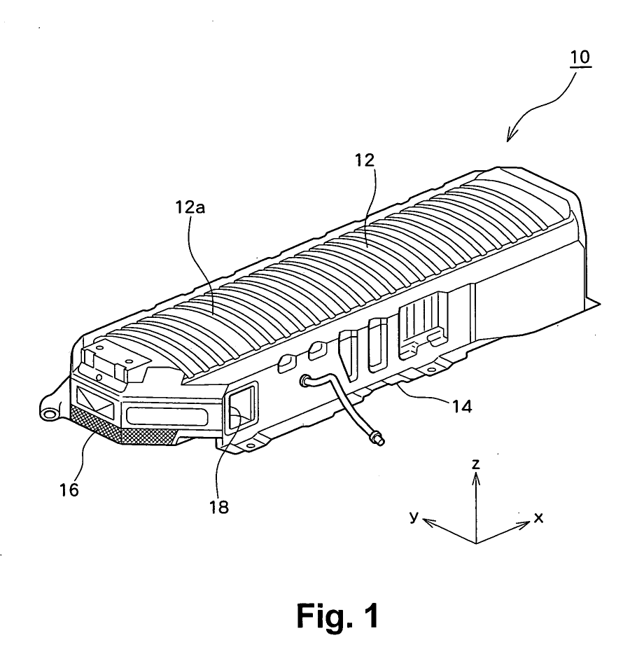

FIG. 1 is a perspective view showing an external appearance of a battery pack (vehicle power supply) 10 according to the embodiment of the present invention. A battery case serving as a housing for the battery pack 10 has an upper case 12 for covering an upper portion of a built-in battery stack 20 and a lower case 14 for covering a lower portion of the battery stack 20. The battery pack 10 has a battery assembly (battery stack 20) built therein, wherein a plurality of battery modules including one or more single cells, such as nickel-metal hydride batteries or the like, are arranged in parallel (stacked) with a cooling passage interposed therebetween, the battery modules are assembled by restraining end components arranged at their both ends, and the battery modules are electrically connected in series to each other. Further, a cooling fan 15 is provided in the battery pack 10. An air intake port 16 is provided on one side surface of the battery pack 10, or, preferably, on a surface opposing the cooling fan 15, and a lattice-shaped louver for preventing entry of foreign matter is provided on the air intake port 16. In addition, a filter may be provided on the inside of the air intake port 16. An air exhaust port 18 is provided on another side surface of the battery pack 10. When the cooling fan 15 is driven to rotate, air in a passenger compartment is taken in through the air intake port 16, and is supplied to a second chamber space 24 formed between the battery stack 20 and the lower case 14, flowing from below the battery stack 20 to above to reach a first chamber space 22 formed between the battery stack 20 and the upper case 12 to be exhausted to the outside through the air exhaust port 18.

The upper case 12 of the battery pack 10 is not flat and has a predetermined curvature so as to protrude upward, or toward the outside of the battery pack 10 to form an arch shape or a convex surface. Further, the upper case 12 is provided with a groove-shaped bead portion 12a that protrudes toward the inside of the battery pack 10. As shown in the FIG. 1, when it is assumed that a longitudinal direction of the battery pack 10 is an “x” direction, a width direction perpendicular to the “x” direction is a “y” direction, and a height direction is a “z” direction, then the curvature of the upper case 12 is provided in the y-z plane, and the bead portion 12a is also provided along the y-z plane. When it is mounted on a vehicle so that the longitudinal direction of the battery pack 10 matches with the width direction of the vehicle, the “x” direction matches with a width direction of the vehicle, the “y” direction matches with a front and rear direction of the vehicle, and the “z” direction matches with a height direction of the vehicle. This means that the curvature of the upper case 12 is provided in the front and rear direction of the vehicle. In other words, a stacking direction of the battery stack 20 is in the longitudinal direction, or, that is, the “x” direction, and the curvature of the upper case 12 is formed in a direction perpendicular to the stacking direction. By employing the arch shape and the bead portion 12a, the stiffness of the battery pack 10 against loads applied from above can be improved.

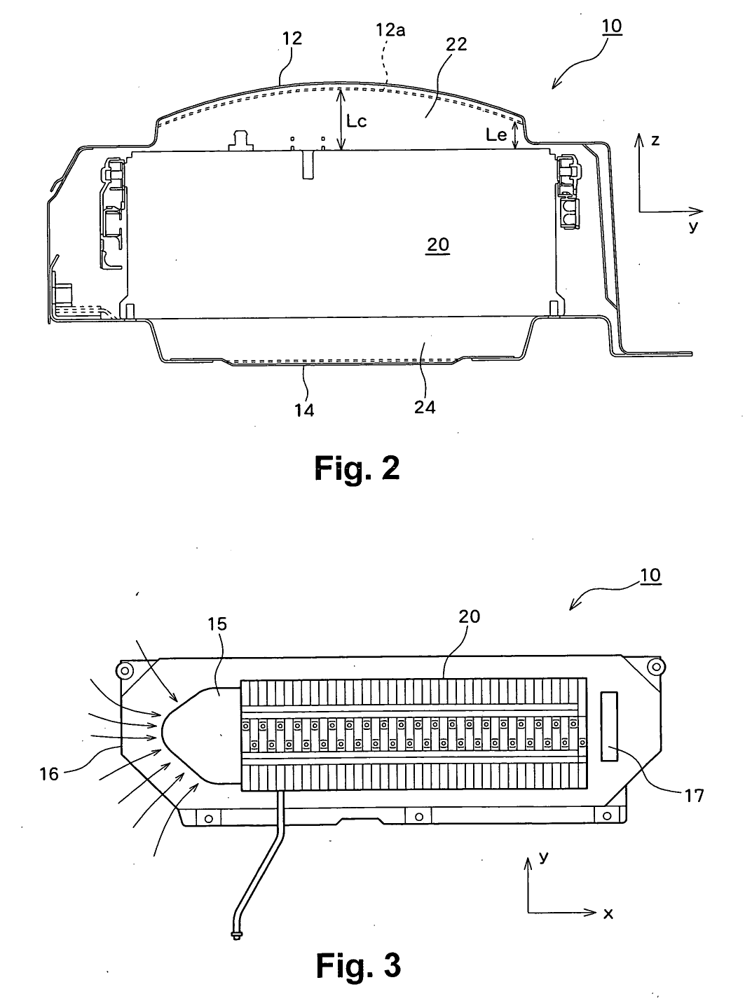

FIG. 2 shows a vertical cross-sectional view (y-z plane cross-sectional view) of the battery pack 10. The chamber space (first chamber space) 22 is formed between the built-in battery stack 20 and the upper case 12, and the chamber space (second chamber space) 24 is formed between the battery stack 20 and the lower case 14. As described above, cooling air flows from the (lower) chamber space 24 toward the (upper) chamber space 22, or, in other words, from below upward in the FIG. 2 to cool the battery stack 20. Because the upper case 12 is formed with the curved surface or the convex surface, a height size “Lc” at a central portion of the chamber space 22, or, in other words, at a central portion of the battery stack 20 in the “y” direction, is greater than a height size “Le” at end portions, or, in other words, at both ends of the battery stack 20 in the “y” direction.

According to the present embodiment, by forming the upper case 12 with the curved surface or the convex surface, deformation or collapsing of the upper case 12 can be prevented even if a load is applied from above, and it is simultaneously possible to improve the cooling properties of the battery stack 20. More specifically, there are properties such that heat is more easily dissipated and cooling is more easily performed at both ends of the battery stack 20 than at the central portion. Therefore, when the upper case 12 is formed with the flat surface, Lc=Le, because it has substantially the same cooling air conduction resistance both at the central portion and the end portions, the end portions are cooled more than the central portion, thus causing uneven cooling properties, or, in other words, unsatisfactory cooling at the central portion. On the other hand, because the upper case 12 of the battery pack 10 according to the present embodiment is formed with the curved surface and has a relationship of Lc>Le, cooling air conduction resistance at the central portion is lower than at the end portions, or a greater amount of cooling air is supplied to the central portion than to the end portions. This makes it possible to suppress cooling at the end portions or to increase cooling at the central portion. Thus, uniform cooling properties or prevention of insufficient cooling at the central portion can be achieved. In other words, the upper case 12 of the present embodiment can simultaneously accomplish improved load-bearing characteristics for loads applied from above and improved cooling properties of the battery stack 20. The curved surface of the upper case 12 may also be used to serve both as a supporting means for supporting loads applied from above and as an adjustment means for adjusting distribution of the amount of supply of the cooling air supplied to the battery stack 20. The upper case 12 may have any desired curvature or radius of curvature, and can be made to have a radius of curvature of, for example, about one meter. The curvature of the upper case 12 is usually to be limited according to a space utility of the vehicle on which the battery pack 10 is to be mounted. When the battery pack 10 is to be mounted below a vehicle rear seat 34 of the vehicle, the curvature of the upper case 12 is set according to the size of space formed between an under surface of the rear seat 34 and the battery pack 10. Because the curvature of the upper case 12 has an influence on the cooling properties of the battery stack 20, it is preferable that the curvature is set such that uniform cooling can be achieved at the central portion and at the end portions in the battery stack 20.

FIG. 3 shows an internal structure of the battery pack 10 in a state in which the upper case 12 is removed. The battery stack 20 is formed by stacking a plurality of the battery modules in the longitudinal direction (“x” direction) of the battery pack 10. In the present embodiment, each battery module includes an integral case which serves as a module exterior component, and six battery cells which are arranged within the integral case and are separated by partitions. The integral case is not particularly limited, but may be made of, for example, resin. The six battery cells included in each battery module are electrically connected in series within the integral case. A cooling fan 15 for supplying the cooling air is provided at one end of the battery stack 20 in the “x” direction, and a control unit 17 for controlling charging and discharging of the battery stack 20 is provided at another end. The control unit 17 performs data communication with a computer mounted on the vehicle to transmit state data of the battery stack 20 to the vehicle computer and to control the battery stack 20 in accordance with a command supplied from the vehicle computer. The air intake port 16 covered with the lattice-shaped louver is provided in front of the cooling fan 15, and, by driving the cooling fan 15, the cooling air from the passenger compartment is taken in, as shown by arrows in the FIG. 3. The cooling air is supplied through a duct to the chamber space 24 which is formed between the lower portion of the battery stack 20 and the lower case 14, flowing from below upward through the battery stack 20 (in the direction perpendicular to the surface of the drawing sheet) to reach the chamber space 22 which is formed between the upper portion of the battery stack 20 and the upper case 12, thereby cooling the battery stack 20 with desired cooling properties. Although the curvature formed in the upper case 12 as shown in FIG. 1 is formed throughout the entire battery pack 10 in the longitudinal direction, it may be formed only directly above the battery stack 20. More specifically, the upper case 12 may be formed to have a curved surface directly above the battery stack 20, and formed to have a flat surface directly above the cooling fan 15 or the control unit 17.

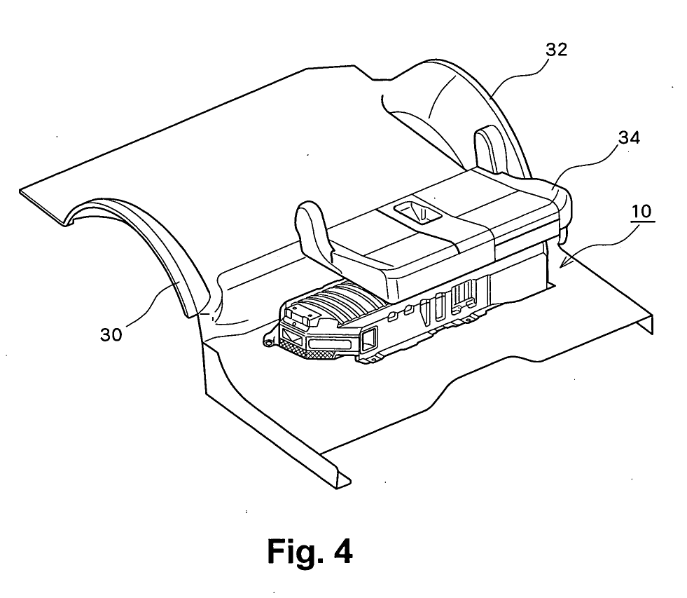

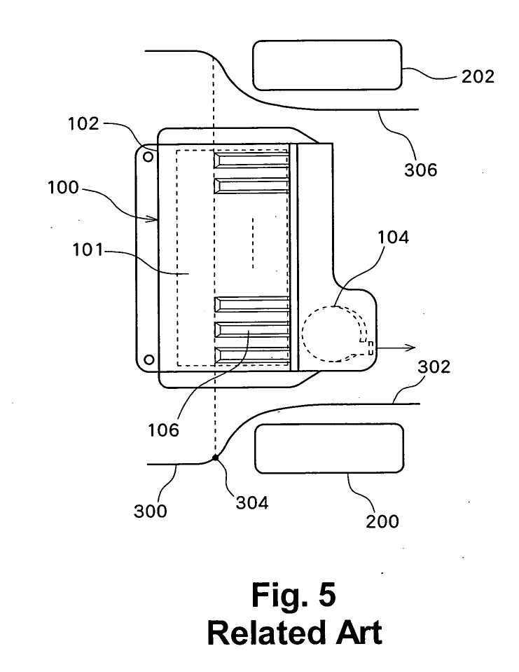

FIG. 4 shows a state in which the battery pack 10 is mounted on the vehicle. The battery pack 10 is located below a seat surface of the rear seat 34 provided between wheel houses 30 and 32 for rear tires. The rear seat 34 is of a fold-down type and, when folded down to form a combined space with luggage space, is capable of providing enlarged luggage space. When luggage or the like is mounted on the rear seat 34, a load will also be applied to the upper case 12 of the battery pack 10. However, in the present embodiment, because the upper case 12 is formed with the curved surface, or the convex surface facing vertically upward, the load-bearing characteristics for loads applied from above are improved, and the battery stack 20 can be protected without reducing or collapsing the chamber space 22 due to the applied load. Further, the desired cooling properties of the battery stack 20 can be maintained.

Although an embodiment of the present invention has been described above, the present invention is not limited to this embodiment, and other embodiments are also possible within the scope of the technical idea of the present invention.

For example, although according to the above-described embodiment, as shown in FIG. 3, the battery stack 20 and the cooling fan 15 are built in the battery pack 10, the battery stack 20 and the cooling fan 15 may have any positional relationship, and the cooling fan 15 may be provided outside the battery pack 10.

Further, although according to the above-described embodiment, the bead portion 12a is formed on the upper case 12, only a curved surface maybe formed without forming the bead portion 12a.

Further, although according to the above-described embodiment, the structure is configured to allow the cooling air to flow from below to above the battery stack 20, the structure may also be configured to allow the cooling air to flow from above to below the battery stack 20. In either case, the upper case 12 has the chamber space 22 for the cooling air formed above the battery stack 20, and the distribution of the flow rate of the cooling air supplied to the chamber space 22 can be adjusted in accordance with the curved surface of the upper case 12.

Further, although according to the above-described embodiment, the curvature of the upper case 12 is made uniform, the curvature maybe changed according to the position. In short, it is sufficient if the curved surface is formed on the upper case 12 so as to improve the load-bearing characteristics with the curved surface, and to adjust distribution of the amount of supply of the supplied air to achieve desired properties.

What is claimed is:

1. A housing structure for a battery pack to be mounted on a vehicle, the housing structure comprising:
an upper case for covering an upper portion of a built-in battery stack,
wherein at least a part of the upper case has a curved surface formed to protrude upward.

2. The housing structure according to claim 1, wherein:
the upper case has a chamber space formed above the battery stack; and
a medium for adjusting a temperature of the battery stack is supplied to the chamber space.

3. The housing structure according to claim 2, wherein the curved surface of the upper case is formed such that the chamber space is enlarged at a central portion of the battery stack, and such that the chamber space is reduced at end portions of the battery stack.

4. The housing structure according to claim 1, wherein a bead portion is further provided on an inner surface side of the upper case.

5. The housing structure according to claim 1, wherein:
the battery pack is to be mounted on a vehicle so that a longitudinal direction of the battery pack matches with a width direction of the vehicle; and
the curved surface is formed in a front and rear direction of the vehicle in a state in which the battery pack is mounted on the vehicle.

6. A vehicle comprising:
a battery pack below a seat surface of a vehicle rear seat, and is to be driven by power supplied from the battery pack, wherein the battery pack has a curved surface formed so as to protrude upward in at least a part of an upper case for covering an upper portion of a built-in battery stack, and has a chamber space formed above the battery stack such that a flow rate of a medium for adjusting a temperature of the battery stack is increased at a central portion of the stack to be greater than that at end portions of the stack in accordance with the curved surface.

7. A housing structure for a battery pack to be mounted on a vehicle, the housing structure comprising:
an upper case for covering an upper portion of a built-in battery stack; and
a lower case for covering a lower portion of the battery stack, wherein:
a first chamber space is formed between the upper case and the upper portion of the battery stack;
a second chamber space is formed between the lower case and the lower portion of the battery stack;
a medium for adjusting a temperature of the battery stack is supplied so as to flow from one of the first chamber space and the second chamber space to another; and
the upper case is formed with a curved surface such that an amount of supply of the medium relatively increases at a central portion of the battery stack, and such that an amount of supply of the medium relatively decreases at end portions of the battery stack.

8. A housing structure for a battery pack to be mounted on a vehicle, the housing structure comprising:
an upper case for covering an upper portion of a built-in battery stack; and
a lower case for covering a lower portion of the battery stack,
wherein the upper case comprises:
load-supporting means for supporting a load applied from above the battery pack; and
adjustment means for adjusting distribution of an amount of supply of a medium supplied to the battery stack, and
wherein the load-supporting means also serves as the adjustment means.

9. The housing structure according to claim 8, wherein the adjustment means performs adjustment so that the amount of supply of the medium increases at a central portion of the battery stack, and decreases at end portions of the battery stack.

10. The housing structure according to claim 8, wherein a convex surface formed on the upper case serves as both the load-supporting means and the adjustment means.
